(19) United States
(12) Patent Application Publication
(10) Pub. No.: US 2026/0113692 A1
(43) Pub. Date: Apr. 23, 2026

(54) NETWORK DISCOVERY METHOD, FIRST DEVICE AND SECOND DEVICE

(71) Applicant: GUANGDONG OPPO MOBILE TELECOMMUNICATIONS CORP., LTD., Dongguan (CN)

(72) Inventor: Weijie XU, Dongguan (CN)

(21) Appl. No.: 19/428,421

(22) Filed: Dec. 22, 2025

Related U.S. Application Data
(63) Continuation of application No. PCT/CN2023/106236, filed on Jul. 7, 2023.

(51) Int. Cl. H04W 48/08

(52) U.S. Cl. CPC H04W 48/08

(57) ABSTRACT

A network discovery method includes: a first device transmits a discovery request on a first channel. The discovery request is used for indicating or requesting a second device on the first channel to transmit discovery request response information, and the discovery request response information includes network deployment information.

### CROSS-REFERENCE TO RELATED APPLICATION

This application is a Continuation Application of International Application No. PCT/CN2023/106236 filed on Jul. 7, 2023, which is incorporated herein by reference in its entirety.

### TECHNICAL FIELD

The present disclosure relates to the field of communications, and in particular, to a network discovery method, a first device, a second device, a chip, a computer-readable storage medium, a computer program product, a computer program, and a communication system.

### BACKGROUND

Before performing communication with a network device, a terminal device is required to discover the network device through an operation of scanning a frequency, that is, search for a signal transmitted by the network device on the frequency. Frequency scanning need to consume a lot of power. Therefore, it is necessary to consider how to perform a network discovery to save the power.

### SUMMARY

Embodiments of the present disclosure provide a network discovery method, including:
transmitting, by a first device, a discovery request on a first channel; where the discovery request is used for indicating or requesting a second device on the first channel to transmit discovery request response information, and the discovery request response information includes network deployment information.

Embodiments of the present disclosure provide a network discovery method, including:
in response to receiving a discovery request from a first device on a first channel, transmitting, by a second device, discovery request response information to the first device, where the discovery request response information includes network deployment information.

Embodiments of the present disclosure provide a first device, including:
a first communication module, configured to transmit a discovery request on a first channel; where the discovery request is used for indicating or requesting a second device on the first channel to transmit discovery request response information, and the discovery request response information includes network deployment information.

Embodiments of the present disclosure provides a second device, including:
a second communication module, configured to transmit discovery request response information to a first device in response to receiving a discovery request from the first device on a first channel, where the discovery request response information includes network deployment information.

Embodiments of the present disclosure provide a first device, including a processor and a memory. The memory is configured to store a computer program, and the processor is configured to call the computer program stored in the memory and run the computer program to enable the first device to perform the above-mentioned network discovery method.

Embodiments of the present disclosure provide a second device, including a processor and a memory. The memory is configured to store a computer program, and the processor is configured to call the computer program stored in the memory and run the computer program to enable the second device to perform the above-mentioned network discovery method.

Embodiments of the present disclosure provide a chip for implementing the above-mentioned network discovery method.

For example, the chip includes a processor configured to call a computer program from a memory and run the computer program to enable a device equipped with the chip to perform the above-mentioned network discovery method.

Embodiments of the present disclosure provide a non-transitory computer-readable storage medium configured to store a computer program. The computer program, when executed by a device, enables the device to perform the above-mentioned network discovery method.

Embodiments of the present disclosure provide a computer program product, including computer program instructions. The computer program instructions enable a computer to perform the above-mentioned network discovery method.

Embodiments of the present disclosure provide a computer program. The computer program, when run on a computer, enables the computer to perform the above-mentioned network discovery method.

### BRIEF DESCRIPTION OF THE DRAWINGS

FIG. 1 is a schematic diagram illustrating a communication system according to an embodiment of the present disclosure.

FIG. 2 is a schematic diagram of a zero-power consumption communication network.

FIG. 3 is a diagram illustrating a principle of radio frequency (RF) power harvesting.

FIG. 4 is a diagram illustrating a principle of back scattering communication.

FIG. 5 is a schematic diagram of resistive load modulation.

FIG. 6A is a schematic diagram of Non-Return-to-Zero (NRZ) coding.

FIG. 6B is a schematic diagram of Manchester coding.

FIG. 6C is a schematic diagram of Unipolar Return-to-Zero coding.

FIG. 6D is a schematic diagram of Differential Binary Phase (DBP) coding.

FIG. 6E is a schematic diagram of Miller coding.

FIG. 7 is a schematic flowchart of a transmission method according to an embodiment of the present disclosure.

FIG. 8 is a schematic flowchart of a transmission method according to another embodiment of the present disclosure.

FIG. 9 is a flowchart of an application example of the present disclosure.

FIG. 10 is a schematic block diagram of a first device according to an embodiment of the present disclosure.

FIG. 11 is a schematic block diagram of a first device according to another embodiment of the present disclosure.

FIG. 12 is a schematic block diagram of a first device according to another embodiment of the present disclosure.

FIG. 13 is a schematic block diagram of a second device according to an embodiment of the present disclosure.

FIG. 14 is a schematic block diagram of a second device according to another embodiment of the present disclosure.

FIG. 15 is a schematic block diagram of a communication device according to an embodiment of the present disclosure.

FIG. 16 is a schematic block diagram of a chip according to an embodiment of the present disclosure.

FIG. 17 is a schematic block diagram of a communication system according to an embodiment of the present disclosure.

### DETAILED DESCRIPTION

Technical solutions in embodiments of the present disclosure are described below in conjunction with drawings of the embodiments of the present disclosure.

The technical solutions in the embodiments of the present disclosure may be applied to various communication systems, such as a new radio (NR) system, an evolution system of an NR system, an NR-based access to unlicensed spectrum (NR-U) system, a non-terrestrial communication network (Non-Terrestrial Network, NTN) system, a wireless local area network (WLAN), a wireless fidelity (WiFi), a 5th-generation (5G) communication system, a 6th-generation (6G) communication system or other communication systems.

Generally speaking, the connections supported by a traditional communication system have a limited number and is easy to implement. However, with the development of the communication technology, a mobile communication system will support not only the traditional communication, but also the terminal to terminal direct communication such as device to device (D2D) communication, machine to machine (M2M) communication, machine type communication (MTC), vehicle to vehicle (V2V) communication, or vehicle to everything (V2X) communication. The embodiments of the present disclosure may also be applied to these communication systems.

In an implementation, the communication system in the embodiments of the present disclosure may be applied to a carrier aggregation (CA) scenario, a dual connectivity (DC) scenario, or a standalone (SA) network deployment scenario.

In an implementation, the communication system in the embodiments of the present disclosure may be applied to an unlicensed spectrum, and the unlicensed spectrum may also be considered as a shared spectrum. Alternatively, the communication system in the embodiments of the present disclosure may also be applied to a licensed spectrum, and the licensed spectrum may also be considered as an unshared spectrum.

In the embodiments of the present disclosure, various embodiments are described in conjunction with a network device and a terminal device. The terminal device may also be referred to as a user device (user equipment, UE), an access terminal, a user unit, a user station, a mobile station, a mobile console, a remote station, a remote terminal, a mobile device, a user terminal, a terminal, a wireless communication device, a user agent or a user apparatus, or the like.

The terminal device may be a station (ST) in the WLAN, which may be a cellular phone, a cordless phone, a session initiation protocol (SIP) phone, a wireless local loop (WLL) station, a personal digital assistant (PDA) device, a handheld device with a wireless communication function, a computing device or one of other processing devices connected to a wireless modem, a vehicle-mounted device, a wearable device, a terminal device in a next-generation communication system such as an NR network, a terminal device in a future evolutional public land mobile network (PLMN), or the like.

In the embodiments of the present disclosure, the terminal device may be deployed on land, which includes indoor or outdoor, handheld, wearable or vehicle-mounted device, the terminal device may also be deployed on water (e.g., on a ship) or below the water (e.g., on a submarine), and the terminal device may also be deployed in the air (e.g., on an airplane, a balloon, or a satellite).

In the embodiments of the present disclosure, the terminal device may be a mobile phone, a pad, a computer with a wireless transceiving function, a virtual reality (VR) terminal device, an augmented reality (AR) terminal device, a terminal device in personal Internet of things (IoT), a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, or the like.

As an example but not limitation, in the embodiments of the present disclosure, the terminal device may also be a wearable device. The wearable device, which may be also referred to as a wearable smart device, is a general term for wearable devices developed by performing intelligent design on daily wear (such as glasses, gloves, a watch, clothing, or shoes) applying wearable technologies. The wearable device is a portable device that is worn directly on a body or is integrated into a user's clothing or accessory. The wearable device is not merely a hardware device, and achieves powerful functions through software support, data interaction and cloud interaction. Generalized wearable smart devices include a device (such as a smart watch or smart glasses) that has full functionality and large-size, and may realize all or partial functions without relying on a smartphone, and a device (such as various smart bracelets or smart jewelries for monitoring physical signs) that only focuses on a certain type of application function and needs to be used in conjunction with other devices such as a smartphone.

In the embodiments of the present disclosure, the network device may be a device for communicating with the mobile device, and the network device may be an access point (AP) in a WLAN, a network device (gNB) in an NR network, a network device in a future evolutional PLMN network, a network device in an NTN network, or the like.

As an example but not limitation, in the embodiments of the present disclosure, the network device may have mobile characteristics. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, or a high elliptical orbit (HEO) satellite. Optionally, the network device may also be a base station deployed on land, water, or other positions.

In the embodiments of the present disclosure, the network device may provide services for a cell, and the terminal device communicates with the network device through transmission resources (e.g., frequency domain resources, or frequency spectrum resources) used by the cell. The cell may be a cell corresponding to the network device (e.g., the base station). The cell may belong to a macro base station or a base station corresponding to a small cell. The small cell here may include a metro cell, a micro cell, a pico cell, a femto cell, or the like. These small cells have characteristics of small coverage and low transmitting power, and are applicable for providing high-speed data transmission services.

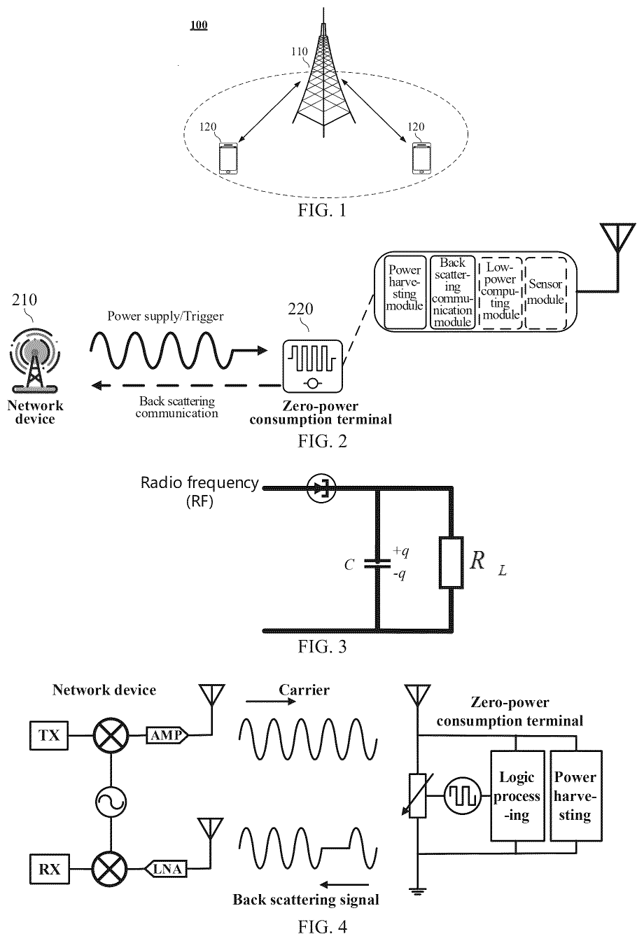

FIG. 1 exemplarily illustrates a communication system 100. The communication system includes one network device 110 and two terminal devices 120. In a possible implementation, the communication system 100 may include a plurality of network devices 110, and there may be another number of terminal devices 120 within coverage of each network device 110, which are not limited in the embodiments of the present disclosure.

It should be understood that the terms “system” and “network” are often used interchangeably herein. Herein, the term “and/or” is only an association relationship to describe associated objects, which means that there may be three kinds of relationships. For example, A and/or B may represent three cases that: A exists alone, both A and B exist, and B exists alone. In addition, a character “/” herein generally means that related objects before and after “/” are in an “or” relationship.

It should be understood that “indication” mentioned in the embodiments of the present disclosure may mean a direct indication or an indirect indication, or may represent an association. For example, A indicates B, which may mean that A directly indicates B (e.g., B may be obtained by A), or may mean that A indirectly indicates B (e.g., A indicates C, and B may be obtained by C), or may mean that there is an association between A and B.

In the description of the embodiments of the present disclosure, the term “corresponding” may mean that there is a direct correspondence or indirect correspondence between two, or may mean an association between the two, or may mean a relationship of indicating and being indicated or a relationship of configuring and being configured, etc.

In order to facilitate understanding of the technical solutions of the embodiments of the present disclosure, the related technologies of the embodiments of the present disclosure are described below. The related technologies below, as optional solutions, may be arbitrarily combined with the technical solutions of the embodiments of the present disclosure, all of the combinations belong to the protection scope of the embodiments of the present disclosure.

### I. Technical Principle of Zero-Power Consumption Communication

Zero-power consumption communication adopts power harvesting and back scattering communication technology. FIG. 2 illustrates a schematic diagram of a zero-power consumption communication network. As illustrated in FIG. 2, the zero-power consumption communication network includes a network device 210 and a zero-power consumption terminal 220 (also referred to as a zero-power consumption device). The network device 210 is configured to transmit a wireless power supply signal and a downlink communication signal (e.g., a trigger signal) to the zero-power consumption terminal 220, and receive a back scattering signal from the zero-power consumption terminal 220. The basic zero-power consumption terminal 220 includes a power harvesting module, a back scattering communication module, and a low-power computing module. In addition, the zero-power consumption device may further have a memory for storing some basic information (e.g., object identification) or a sensor for obtaining sensing data such as ambient temperature and ambient humidity.

The key technologies of the zero-power consumption communication mainly include radio frequency (RF) power harvesting and back scattering communication.

FIG. 3 illustrates a diagram of the principle of RF power harvesting. As illustrated in FIG. 3, an RF power harvesting module harvests electromagnetic wave energy in space based on the principle of electromagnetic induction, so as to obtain the power required for driving the zero-power consumption device to work, for example, for driving a low-power demodulation and modulation module, a sensor and memory reading. Therefore, the zero-power consumption device does not need a conventional battery.

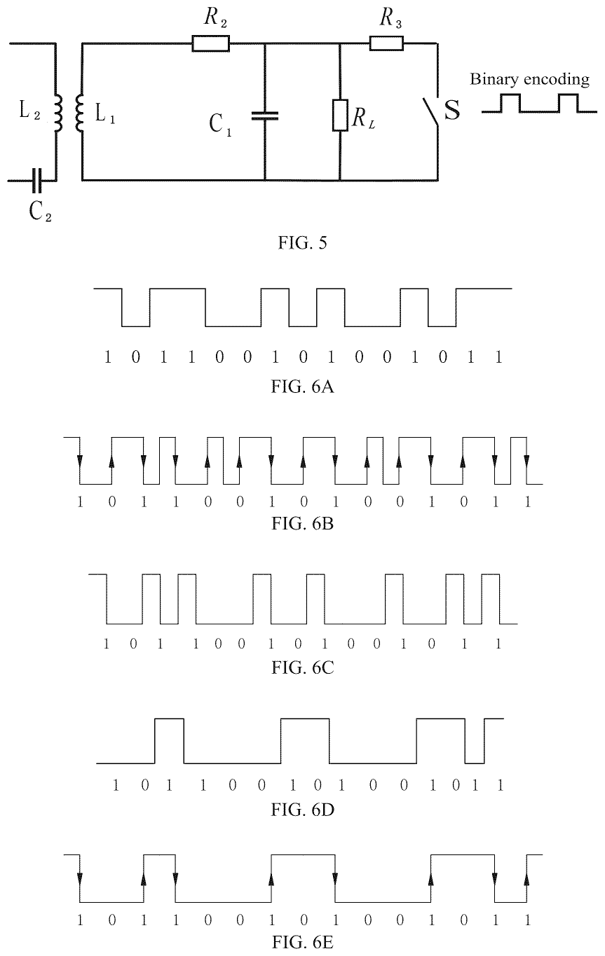

FIG. 4 illustrates a diagram of the principle of the back scattering communication. As illustrated in FIG. 4, the zero-power consumption terminal receives a wireless signal transmitted by the network, modulates the wireless signal, load the information to be sent, and radiates a modulated signal via antenna(s). This information transmission process is referred to as back scattering communication. Back scattering is inseparable from load modulation function. During the load modulation, circuit parameters of an oscillation loop of the zero-power consumption device are adjusted and controlled according to a beat of a data stream, so that parameters such as an impedance of an electronic tag are changed accordingly, thereby completing the modulation process. Load modulation technology mainly includes two methods: resistive load modulation and capacitive load modulation. FIG. 5 illustrates a schematic diagram of the resistive load modulation. As illustrated in FIG. 5, in the resistive load modulation, a resistor R₃ is connected in parallel with a load R_{L}, and the resistor R₃ is switched on or off based on control of a binary data stream (e.g., switch on or switch off is achieved through a control switch S). The on/off of the resistor may cause a change in a voltage of a circuit, thus realizing amplitude shift keying (ASK) modulation. That is, modulation and transmission of the signal is achieved by adjusting the amplitude of the back scattering signal of the zero-power consumption device. Similarly, in the capacitive load modulation, on/off of the capacitor may cause a change in a resonant frequency of the circuit, thereby achieving frequency shift keying (FSK) modulation. That is, modulation and transmission of the signal is achieved by adjusting the operating frequency of the back scattering signal of the zero-power consumption device.

It can be seen that the zero-power consumption device performs information modulation on an incoming wave signal by means of load modulation, thereby achieving the back scattering communication process. Therefore, the zero-power consumption device has following significant advantages:
1. a terminal does not actively transmit a signal, and thus a complex RF link (e.g., a power amplifier (PA), or an RF filter) is not required;
2. a terminal does not need to actively generate a high-frequency signal, and thus a high-frequency crystal oscillator is not required; and
3. by means of back scattering communication, signal transmission of a terminal does not need to consume the terminal's own power.

### III. Extremely Low-Power Consumption Active Transmission Technique

The zero-power consumption device may also use extremely low-power consumption active transmission technique. Different from back scattering, when the zero-power consumption device performs data transmission using the extremely low-power consumption active transmission, the zero-power consumption device needs to generate a radio frequency carrier by using a relatively simple and low-power consumption oscillator, and then modulate the information to be transmitted onto the radio frequency carrier. Based on the current research, the power consumption of extremely low-power consumption active transmitter may be as low as hundreds of microwatts, so that ultra-low power consumption data transmission may be achieved.

### IV. Application Scenario of Zero-Power Consumption Communication

Due to significant advantages such as extremely low cost, zero-power consumption and small size, the zero-power consumption communication may be widely used in various industries, such as vertical industry-oriented logistics, smart warehousing, smart agriculture, energy and power, and industrial Internet. Alternatively, the zero-power consumption communication may also be applied to personal applications such as a smart wearable and a smart home.

### V. Encoding (Coding) Manner of Zero-Power Consumption Communication

For the data transmitted by the zero-power consumption terminal (e.g., the electronic tag), binary “1” and “0” may be represented in different forms of codes. The radio frequency identification system typically uses one of the following coding manners: Non-Return-to-Zero (NRZ) coding, Manchester coding, unipolar RZ coding, Differential Binary Phase (DBP) coding, Miller coding and differential coding. Generally speaking, different pulse signals are used to represent 0 and 1.

FIG. 6A is a schematic diagram illustrating NRZ coding. As illustrated in FIG. 6A, NRZ coding represents a binary “1” with a high level and a binary “0” with a low level.

FIG. 6B is a schematic diagram illustrating Manchester coding. Manchester coding is referred to as split-phase coding. As illustrated in FIG. 6B, in Manchester coding, a value of a bit is represented by the level change (rise/fall) at half a bit period within the length of the bit, with a negative transition at half the bit period indicating the binary “1” and a positive transition at half the bit period indicating the binary “0”. When using the load modulation or the back scattering modulation for the carrier, Manchester coding is usually used for data transmission from an electronic tag to a reader/writer, since this is beneficial to detect errors in data transmission. The reason is that a state of “no change” is not allowed within the length of the bit. In a case where data bits transmitted by a plurality of electronic tags simultaneously have different values, received rising and falling edges offset each other, resulting in an uninterrupted carrier signal throughout the entire length of the bit. Since this state is not allowed, the reader/writer may determine the location of the collision uing this error.

FIG. 6C illustrates a schematic diagram of unipolar return-to-zero coding. As illustrated in FIG. 6C, for the unipolar return-to-zero coding, the high level in the first half bit period represents a binary “1”, while the low level signal lasting for the entire bit period represents a binary “0”. Unipolar return-to-zero coding may be used to extract a bit synchronization signal.

FIG. 6D illustrates a schematic diagram of DBP coding. As illustrated in FIG. 6D, any edge of the DBP coding within half the bit period represents a binary “0”, while “no edge” is a binary “1”. Furthermore, at the beginning of each bit period, the level is inverted. Therefore, the bit beat is relatively easy for the receiver to reconstruct.

FIG. 6E illustrates a schematic diagram of Miller coding. As illustrated in FIG. 6E, any edge of the Miller coding within half the bit period represents a binary “1”, while the level that remains unchanged over the next bit period represents a binary “0”. The level alternation occurs at the beginning of the bit period. Therefore, the bit beat is relatively easy for the receiver to reconstruct.

### VI. Classification of Zero-Power Consumption Terminal

Based on power source and usage mode of the zero-power consumption terminals, the zero-power consumption terminal may be classified into the following types.

### (1) Passive Zero-Power Consumption Terminal

The zero-power consumption terminal does not need a built-in battery. When the zero-power consumption terminal approaches the network device, the zero-power consumption terminal is located within a near field formed by radiation of the antenna(s) of the network device. The network device is, for example, a reader/writer of a radio frequency identification (RFID) system or the like. Therefore, the antenna of the zero-power consumption terminal generates an induced current through electromagnetic induction, and the induced current drives a low-power consumption chip circuit of the zero-power consumption terminal, thereby implementing operations such as demodulation of a forward link signal and modulation of a backward link signal. For the back scattering link, the zero-power consumption terminal may transmit the signal via the back scattering or the extremely low-power consumption active transmission.

It can be seen that the passive zero-power consumption terminal does not need the built-in battery to drive either in the forward link or in the backward link, and is a true zero-power consumption terminal.

The passive zero-power consumption terminal does not need the battery, and the radio frequency circuit and the baseband circuit are very simple. For example, a low-noise amplifier (LNA), a power amplifier (PA), a crystal oscillator, an analog-to-digital converter (ADC) and other devices are not needed. Therefore, the passive zero-power consumption terminal has many advantages such as small size, light weight, very low price, and long service life.

The passive zero-power consumption terminal may also support other power harvesting manners. By harvesting ambient powers (e.g., light power, heat power, kinetic power, and mechanical power), the power for the driving circuit is obtained to support the communication of the terminal device.

### (2) Semi-Passive Zero-Power Consumption Terminal

The semi-passive zero-power consumption terminal itself does not have a conventional battery installed, but can harvest radio wave power by using an radio frequency (RF) power harvesting module or harvest ambient powers (e.g., solar power, heat power, and mechanical vibration power) by using a power harvesting module; and meanwhile store the harvested power in a power storage unit (e.g., a capacitor). After obtaining the power, the power storage unit can drive a low-power consumption chip circuit of the zero-power consumption terminal, thereby implementing operations such as demodulation of a forward link signal and modulation of a backward link signal. For the backward link, the zero-power consumption terminal may transmit the signal via the back scattering or the extremely low-power consumption active transmission.

It can be seen that the semi-passive zero-power consumption terminal does not need a built-in battery to drive either in the forward link or in the backward link. Although the power stored in the capacitor is used in operation, the power comes from radio power harvested by the power harvesting module. Therefore, the semi-passive zero-power consumption device is also a true zero-power consumption terminal.

The semi-passive zero-power consumption terminal inherits many advantages of the passive zero-power consumption terminal, and thus has many advantages such as small size, light weight, very low price and long service life.

### (3) Active Zero-Power Consumption Terminal

The zero-power consumption terminal used in some scenarios may be the active zero-power consumption terminal, and such a terminal may have a built-in battery (a conventional battery such as a dry battery or a rechargeable lithium battery). The battery is used to drive the low-power consumption chip circuit of the zero-power consumption terminal, thereby implementing operations such as demodulation of the forward link signal and modulation of the backward link signal. However, for the backward link, the zero-power consumption terminal may transmit the signal via the back scattering or the extremely low-power consumption active transmission. Therefore, zero-power consumption of the back scattering terminal is mainly embodied in that the signal transmission on the backward link does not need the terminal's own power, but uses the back scattering manner. Although the active zero-power consumption terminal uses the battery, the power consumption is very low due to the use of ultra-low power consumption communication technique, so that the working life of the battery may be greatly improved.

The active zero-power consumption terminal, with the built-in battery to supply power to RFID chip, increases a reading and writing distance of the tag and improves the reliability of communication. Therefore, the active zero-power consumption terminal may be applied in some scenarios with relatively high requirements on the communication distance, the reading delay, or the like.

It is well-known that the service type of the zero-power consumption IoT is similar to that of other IoTs, which also focus on uplink services. Based on the type of the transmitter of the zero-power consumption terminal, the zero-power consumption terminal may be classified into the following types.

### (1) Zero-Power Consumption Device Based on Back Scattering

This type of zero-power consumption device transmits uplink data by means of the back scattering as previously described. Such the device does not have the active transmitter that actively performs transmission, but only has the back scattering transmitter. Therefore, when such the device performs data transmission, the network device needs to provide the carrier, and such the terminal device performs back scattering based on the carrier to realize data transmission.

### (2) Zero-Power Consumption Device Based on the Active Transmitter

This type of zero-power consumption device performs uplink data transmission using the active transmitter with active transmission capability. Therefore, when transmitting data, such the zero-power consumption device may transmit data by using its own active transmitter without the need for the network device to provide the carrier. The active transmitter suitable for the zero-power consumption device may be, for example, an ultra-low power consumption ASK transmitter or an ultra-low power consumption FSK transmitter. Based on current implementations, when such transmitters transmit the signal of 100 uw (microwatts), the overall power consumption may be reduced to 400 uw to 600 uw.

(3) Zero-Power Consumption Device with Both Back Scattering and Active Transmitter

This type of terminal may support both back scattering and active transmitter. The terminal may determine, according to different situations (e.g., power level, and available ambient power) or based on the scheduling of the network device, to use which transmission mode of the uplink signal for active transmission: the back scattering mode or the active transmitter.

### VII. Cellular Passive Internet of Things

The cellular Internet of Things is booming. Currently, IoT technologies such as narrow band Internet of Things (NB-IoT), MTC and Reduced Capability (RedCap) have been standardized. However, there are still IoT communication requirements in many scenarios not be met using existing technologies, and examples are as follows:

### 1. Harsh Communication Environment

Some IoT scenarios may face high temperature, extremely low temperature, high humidity, high pressure, high radiation, high-speed movement, and other extreme environments, such as an ultra-high voltage substation, high-speed train track monitoring, ambient monitoring on alpine-cold zones, and an industrial production line. In these scenarios, the existing IoT terminal will not work due to the working environment limitations of conventional power supplies. In addition, extreme working environments are not conducive to IoT maintenance, such as battery replacement.

### 2. Extremely Small Size Terminal Form Demand

Some IoT communication scenarios, such as food traceability, commodity circulation and smart wearable scenarios, require the terminal to have extremely small size, so as to facilitate use in these scenarios. For example, the IoT terminal used for commodity management in the circulation link usually use the form of electronic tag, which is embedded into commodity packaging in a very compact form. As another example, the lightweight wearable device may improve user experience while meeting user demands.

### 3. Extremely Low-Cost IoT Communication Demand

Numerous IoT communication scenarios require the cost of IoT terminals to be low enough to improve competitiveness compared with other alternative techniques. For example, in logistics or warehousing scenarios, in order to facilitate management of a large number of circulating items, the Internet of Things terminal may be attached to each item, so as to complete the accurate management of the entire logistics process and cycle through the communication between the terminal and the logistics network. These scenarios require the cost of the IoT terminals to be competitive enough.

Therefore, in order to cover these unmet IoT communication demands, the cellular network also need to develop ultra-low-cost, extremely small-size, battery-free/maintenance-free IoT, and the zero-power consumption IoT may just meet the demand.

It should be additionally pointed out that in the discussion process of standardization, the zero-power consumption Internet of Things may also be referred to as the ambient power enabled IoT (ambient IoT). The so-called Ambient IoT (which may also be further referred to as A-IoT) means an IoT device that use various ambient powers, such as wireless radio frequency power, light power, solar power, thermal power, mechanical power and other ambient powers. Such the device may have no power storage capacity, or have very limited power storage capacity (e.g., using the capacitor with a capacity of tens of microfarads (uF)). Compared with the existing IoT device, the ambient power enabled IoT device (ambient IoT device) has many advantages such as conventional battery-free, maintenance-free, small size, low complexity, low cost and long life cycle.

Based on the discussion of application scenarios of the ambient IoT, the ambient IoT may be used in at least the following four types of scenarios:
object recognition, such as logistics, management of production line product and management of supply chain;
ambient monitoring, such as monitoring of temperature, humidity and harmful gas of working environment and natural environment;
positioning, such as indoor positioning, intelligent object search and production line item positioning; and
intelligent control, such as intelligent control (turning on and off the air conditioner, adjusting the temperature) of various electrical appliances in smart home, and intelligent control (automatic watering, fertilization) of various facilities in the agricultural greenhouse.

It can be seen that, in the communication system, there are application scenarios that need to reduce the power consumption of the device. Based on this, it is necessary to consider how to perform the network discovery to save power. For example, the ambient power enabled IoT device do not require the battery, and the radio frequency circuit and the baseband circuit are very simple, and thus the ambient power enabled IoT device has many advantages such as small size, light weight, very low price, long service life and maintenance-free. However, limited by the extremely limited power that can be harvested (the power density of the ambient power is generally very low), the ambient power enabled IoT device need to operate in an extremely low-power consumption manner. Before the ambient power enabled IoT device communicates with the network device, if the network device needs to be discovered (e.g., through frequency scanning operation), it will consume a relatively large amount of power, which poses a great challenge to the ambient power enabled IoT device with extremely limited power. For example, in the industrial scientific medical (ISM) frequency band from 920 megahertz (MHz) to 925 MHz, based on frequency specifications, there are 20 channels divided within the 5 MHz frequency band, and a bandwidth of each channel is 250 kHz. The ambient power enabled IoT may be deployed on each channel, and thus in order to discover the network, the ambient power enabled IoT device may need to scan all channels in the frequency band, which will bring large power consumption.

The technical solutions of the embodiments of the present disclosure are mainly intended to solve at least one of the above-mentioned technical problems.

FIG. 7 is a schematic flowchart of a network discovery method according to an embodiment of the present disclosure. This method may optionally be applied to the system illustrated in FIG. 1, but is not limited thereto. The method includes at least part of the following contents.

In S710, a first device transmits a discovery request on a first channel. The discovery request is used for indicating or requesting a second device on the first channel to transmit discovery request response information, and the discovery request response information includes network deployment information.

In the embodiments of the present disclosure, the first device is a device that needs to discover a network to access the network (or establish an association with the network). Exemplarily, the first device may be a terminal device or an ambient power enabled Internet of Things device.

In the embodiments of the present disclosure, the first channel may be a predetermined channel. That is, unlike scanning each channel one by one in an operating frequency band, in the embodiments of the present disclosure, the first device may determine a certain first channel, and then actively transmit the discovery request on the first channel to obtain the discovery request response information returned by the second device, where the discovery request response information includes the network deployment information.

In the embodiments of the present disclosure, the network deployment information may be used by the first device to complete a network discovery. For example, the network deployment information may include relevant information of a deployment position of the network, such as a frequency position of the channel, or a time domain position of a beacon frame or a broadcast channel. In this way, the first device may perform the network discovery quickly by using the network deployment information. That is, the first device directly searches for the network based on the network deployment information contained in the request response information, thereby avoiding a cumbersome process in which the first device scans each channel one by one within the frequency band and searches for the beacon frame or the broadcast channel on each channel to discover the network.

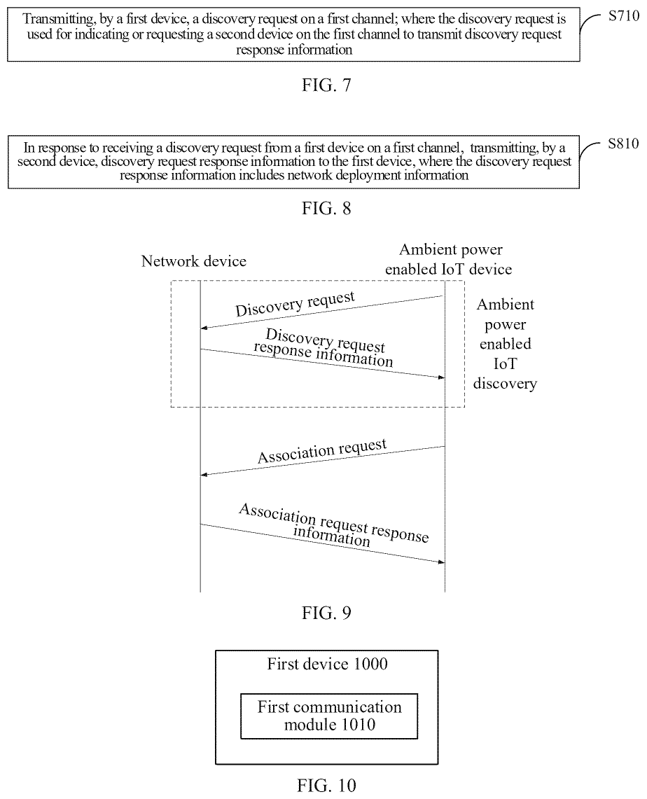

Corresponding to the above embodiments, the present disclosure further provides a transmission method performed by the second device. FIG. 8 is a schematic flowchart of a network discovery method according to another embodiment of the present disclosure. This method may optionally be applied to the system illustrated in FIG. 1, but is not limited thereto. The method includes the following contents.

In S810, in response to receiving a discovery request from a first device on a first channel, a second device transmits discovery request response information to the first device. The discovery request response information includes network deployment information.

In the embodiments of the present disclosure, the second device may be a device in a network on the first channel. Exemplarily, the second device may be a network device. Since the second device will transmit the discovery request response information carrying the network deployment information to the first device in response to receiving the discovery request from the first device, the first device may perform the network discovery by using the network deployment information.

It may be seen that according to the above methods of the embodiments of the present disclosure, the first device actively transmits the discovery request on the certain channel to obtain the network deployment information. Since the network deployment information may be obtained by transmitting the request and receiving the response information on a small number of channels or even one channel, it may save power significantly compared to performing frequency scanning to monitor the beacon of the network on each channel one by one within the operating frequency band to discover the network.

In some embodiments, the network discovery method may further include: the first device receiving the discovery request response information and completes the network discovery based on the network deployment information.

Exemplarily, the network deployment information may be used for determining a position of the network and/or a position of a beacon of the network, thereby completing the network discovery. For example, a network device in each network will transmit a beacon signal on a channel on which the network device is located. The beacon signal includes basic configuration information of the network, so that the terminal may access the network using the basic configuration information. In an actual application, the network discovery performed via frequency scanning includes: scanning various channels within the operating frequency band, and monitoring various channels within the operating frequency band one by one to determine whether there is the beacon signal of the network. That is, it is necessary to wait for scanning/monitoring in both the frequency domain and the time domain. However, in the above embodiments, the first device may obtain the network deployment information by transmitting the discovery request, and determine a frequency position (channel) and/or a time domain position (time domain position of the beacon signal) based on the network deployment information, so as to quickly discover the network and save the power.

In some embodiments, the first device includes a zero-power consumption device or an ambient power enabled Internet of Things (IoT) device. Accordingly, a zero-power consumption IoT or an ambient power enabled IoT may be deployed on the operating frequency band of the first device, and the first device discovers the zero-power consumption IoT/the ambient power enabled IoT within the operating frequency band through the above method.

In some embodiments, the first channel is pre-agreed or configured by the second device.

For example, in a case where the ambient power enabled IoT device operates in an ISM frequency band of 920 MHz to 925 MHz, it may be agreed (through protocol agreement or pre-configuration) that, the 10th channel, or both the 10th and 11th channels within the frequency band are the channels for the ambient power enabled IoT device to transmit the discovery request.

As another example, the first device may receive configuration information transmitted by the network through a beacon channel or through broadcast signaling. When the first device needs to discover the network device next time, the first device may determine the first channel for transmitting the discovery request according to the stored configuration information.

Optionally, N channels for transmitting the discovery request may be pre-agreed or configured, where N is an integer greater than or equal to 2.

In some embodiments, the first channel is randomly determined among N pre-agreed or configured channels. That is, in a case where a plurality of channels are pre-agreed or configured, the first device may randomly select a channel to transmit the discovery request.

In some embodiments, the frequency band where the first channel is located includes M channels, where M is an integer greater than N. Optionally, M is much greater than N, for example, M is five times, ten times or more than N. That is, the number of channels available for transmitting the discovery request is set to be much less than the value of M. It may be seen that the first device needs to transmit the discovery request and receive the discovery request response on only one channel, which has the following advantages.
(1) In a case where there is no network deployed on some channels, it may be avoided that the first device transmits the discovery request on any channel, thereby avoiding power waste caused by inability to receive response from the network device on the channels without network deployed (that is, power waste for transmitting the discovery request and monitoring the response information).
(2) Limited channels for transmitting the discovery request may enable the network device to receive the discovery request only on these (or one of) channels, which is also conducive to simplifying the implementation complexity of the network device and achieving power-saving of the network device.
(3) Limited channels for transmitting the discovery request also correspond to limited positions for transmitting the discovery request response information, thereby further reducing the power consumption of the first device.

In some embodiments, the network deployment information includes at least one of:
relevant information of one or more channels on which the network is deployed; or
relevant information of each network of at least one network.

Exemplarily, the network deployment information may include the relevant information of one or more channels on which the network is deployed. For example, the network deployment information may be used for indicating a channel set, so that the first device may monitor the beacon of the network on one or more channels in the channel set, and thus there is no need for frequency search, thereby saving power consumption and time.

Optionally, the network information may include a first bitmap (also referred to as a bit map, a bitstream, or the like). Each bit in the first bitmap corresponds to a channel, and a bit value 1 or 0 indicates whether the network is deployed on the corresponding channel, thereby realizing indication for one or more channels where the network is deployed. For example, in the ISM frequency band of 920 MHz to 925 MHz, there may be 20 channels according to some frequency specifications. A 20-bit bitmap may be used to indicate whether the network is deployed on the 20 channels within the frequency band.

Exemplarily, the network deployment information may include the relevant information of each network in the at least one network, so that the first device may discover the network based on the relevant information of each network, thereby saving power consumption and time of the first device.

Exemplarily, the network deployment information may include the relevant information of the one or more channels where the network is deployed and the relevant information of the network, so that the first device may discover the network indicated by the network deployment information on the channel indicated by the network deployment information, thereby saving power consumption and time of the first device.

In some embodiments, the at least one network includes a network corresponding to the second device and/or a network discovered by the second device. In addition to responding to information of the network where the second device is located, the second device may also respond to information of other networks.

In some embodiments, the network discovered by the second device includes a first network. The network discovery method may further include: the second device discovering the first network by scanning at least one frequency band. For example, the second device may scan various channels within at least one operating frequency band, discover the first network by monitoring beacons, and obtain the relevant information of the first network. The at least one operating frequency band may include an operating frequency band of the second device. Optionally, the at least one operating frequency band may further include other operating frequency bands. For example, the second device for operating in the ISM frequency band of 920 MHz to 925 MHz may also scan a network within the 2.4 GHz frequency band.

In some embodiments, the network discovery method may further include: the second device transmitting a probe request on at least one channel. The probe request is used for indicating or requesting a third device on the at least one channel to transmit the relevant information of the first network. That is, the second device may discover other networks and obtain relevant information of these networks in an active discovery manner.

In some embodiments, the relevant information of each network includes at least one of:
identification information related to the network;
a channel used by the network;
time-related information of the beacon of the network; or
first attribute information of the network.

In some embodiments, the identification information related to the network includes at least one of a network Identifier (ID), a cell ID, a Service Set Identifier (SSID), or a Basic Service Set Identifier (BSSID).

In some embodiments, the time-related information of the beacon of the network includes a period of the beacon, and/or a time span between the beacon and the discovery request response information. The time-related information may be used by the first device to determine a time domain position of the beacon. Thus, there is no need to waste time monitoring the beacon on the channel, and the network may be discovered quickly.

In some embodiments, the first attribute information of the network includes at least one of: whether the network supports access to the network by the zero-power consumption device capable of communicating via back scattering or the ambient power enabled IoT device capable of communicating via back scattering; an operational level of the network; or whether the network supports wireless power supply. The first attribute information may be used by the first device to determine whether to access and/or an access manner, etc.

It should be noted that in actual applications, the relevant information of the network may include only one piece of information as described above, or may include a combination of a plurality of pieces of information as described above. For example, the relevant information of the network may only include the channel used by the network, and in the case, the first device may monitor the beacon of the network on the channel. Since frequency scanning is not required, energy and power consumption may be saved. For example, the relevant information of the network may include the identification information related to the network, the channel used by the network, and time-related information of the beacon of the network, so that the first device may accurately locate the network without scanning the frequency and spending time on monitoring, thereby further saving energy and power consumption. Those skilled in the art may set the relevant information of the network included in the network deployment information according to scenario requirements, protocol agreements or system agreements, where the relevant information is not listed in detail here one by one.

In some embodiments, the network discovery method may further include: in response to determining relevant information of a plurality of networks based on one or more pieces of discovery request response information, the first device selecting a second network from the plurality of networks for access. The second network may be any network.

That is, in a case where the first device may determine the relevant information of the plurality of networks based on one piece of discovery request response information, or in a case where the first device receives the plurality of pieces of discovery request response information, the first device may select one of the networks for access, for example, randomly selects a network for access.

In some embodiments, the network discovery method may further include: in response to determining relevant information of a plurality of networks based on one or more pieces of discovery request response information, the first device accessing each of the plurality of networks separately.

That is, in a case where the first device may determine the relevant information of the plurality of networks based on one piece of discovery request response information, or in a case where the first device receives the plurality of pieces of discovery request response information, the first device may try to access each network separately until an access is allowed by the network.

In some embodiments, the first device may determine a position of the beacon of the network based on the discovery request response information, receive the beacon based on the position, and access the network using the network configuration information in the beacon.

FIG. 9 is a schematic diagram illustrating an application example of the present disclosure. As illustrated in FIG. 9, according to an embodiment of the present disclosure, the network discovery process of the ambient power enabled Internet of Things may include: an ambient power enabled Internet of Things device transmitting, on a first channel, a discovery request to a network device in the ambient power enabled Internet of Things, and in response to receiving the discovery request, the network device transmitting discovery request response information to the ambient power enabled Internet of Things device. Based on this, the ambient power enabled Internet of Things device completes the network discovery, and transmits an association request to the network device based on the information obtained from the network discovery, so as to obtain association request response information and establish an association between the network device and the ambient power enabled Internet of Things device.

It may be seen that the embodiments of the present disclosure are applied to a scenario of the ambient power enabled Internet of Things, so that the ambient power enabled Internet of Things device may realize the discovery of the ambient power enabled Internet of Things through greatly simplified steps, thereby greatly saving the power consumption of the device.

In some embodiments, the discovery request response information further includes frequency deviation information, and the frequency deviation information is used by the first device to calibrate the operating frequency of the first device.

Exemplarily, the frequency deviation information may be determined based on the discovery request or a first signal transmitted by the first device. The first signal may be a signal transmitted simultaneously or successively with the discovery request, and the transmitting order of the first signal and the discovery request is not limited. The first signal may be transmitted first and then the discovery request is transmitted, or the discovery request may be transmitted first and then the first signal is transmitted. For example, the frequency deviation information may include a frequency error for transmitting the discovery request or the first signal. The second device transmits the discovery request response information carrying the frequency deviation information, so that the first device may calibrate the operating frequency thereof based on the frequency deviation information, for example, by adjusting an oscillator to obtain an accurate clock frequency.

In some embodiments, the second device may transmit the discovery request response information on the first channel. The first device may consider that there may be a certain deviation between its own frequency signal and the first channel, and determine the frequency band for receiving the discovery request response information based on the first channel and its own frequency receiving range.

In some embodiments, the second device may transmit the discovery request response information on the frequency band where the discovery request or the first signal is received. That is, when responding, the second device may use a frequency band that is completely consistent with that of the discovery request or the first signal transmitted by the first device. This approach may simplify reception of the response information by the first device.

The above embodiments may be applied to the ambient power enabled Internet of Things. As mentioned above, the ambient power enabled IoT device has a simple circuit structure. In order to achieve low complexity of the device, the crystal oscillator may not be used as the oscillator, but a relatively simple oscillator such as a resistor capacitor (RC) oscillator or a inductive capacitor (LC) oscillator may be used, which has poor clock accuracy and frequency accuracy. By adopting the above embodiments, the ambient power enabled IoT device may obtain its own frequency error while implementing the discovery request, thereby achieving frequency calibration and avoiding signal transmission errors or interference with adjacent channels. Without the need for the complex calculation process required for the ambient power enabled IoT device to perform frequency calibration through signal measurement, rather high frequency calibration accuracy may be achieved.

FIG. 10 is a schematic block diagram of a first device 1000 according to an embodiment of the present disclosure. The first device 1000 may include:
a first communication module 1010 configured to transmit a discovery request on a first channel; where the discovery request is used for indicating or requesting a second device on the first channel to transmit discovery request response information, and the discovery request response information includes network deployment information.

In an implementation, the first communication module 1010 is further configured to:
receive the discovery request response information, and complete a network discovery based on the network deployment information.

In an implementation, the first device 1000 includes a zero-power consumption device or an ambient power enabled Internet of Things device.

In an implementation, the first channel is pre-agreed or configured by the second device.

In an implementation, the first channel is randomly determined from N pre-agreed or pre-configured channels, and N is an integer greater than or equal to 2.

In an implementation, an operating frequency band of the first device 1000 includes M channels, where M is an integer greater than or equal to 1, and M is greater than N.

In an implementation, the network deployment information includes at least one of:
relevant information of one or more channels on which a network is deployed; or
relevant information of each network of at least one network.

In an implementation, the at least one network includes a network corresponding to the second device and/or a network discovered by the second device.

In an implementation, the relevant information of each network includes at least one of:
identification information related to the network;
a channel used by the network;
time-related information of a beacon of the network; or
first attribute information of the network.

In an implementation, the identification information related to the network includes at least one of a network identifier (ID), a cell ID, a service set identifier (SSID), or a basic service set identifier (BSSID).

In an implementation, the time-related information of the beacon of the network includes a period of the beacon, and/or a time span between the beacon and the discovery request response information.

In an implementation, the first attribute information of the network includes at least one of:
whether the network supports access to the network by the zero-power consumption device capable of communicating via back scattering or the ambient power enabled IoT device capable of communicating via back scattering;
an operational level of the network; or
whether the network supports wireless power supply.

In an implementation, as illustrated in FIG. 11, the first device 1000 further includes a first processing module 1110 configured to:
in response to determining relevant information of a plurality of networks based on one or more pieces of discovery request response information, select a second network from the plurality of networks for access.

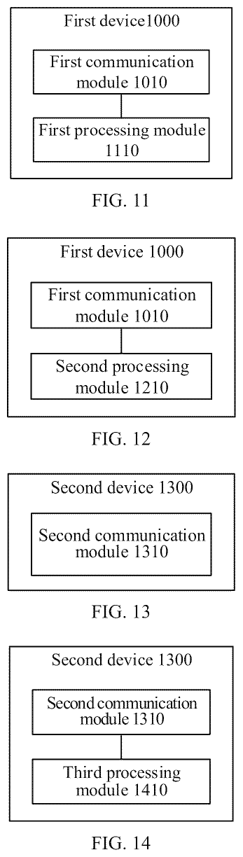

In an implementation, as illustrated in FIG. 12, the first device 1000 further includes a second processing module 1110 configured to:
in response to determining relevant information of a plurality of networks based on one or more pieces of discovery request response information, access each of the plurality of networks separately.

In an implementation, the discovery request response information further includes frequency deviation information, and the frequency deviation information is used to calibrate an operating frequency of the first device 1000.

The first device 1000 in the embodiments of the present disclosure may implement the functions corresponding to the first device in the aforementioned method embodiments. The processes, functions, implementations and beneficial effects corresponding to various modules (sub-modules, units or components, etc.) in the first device 1000 may refer to the corresponding description in the above method embodiments, and details are not repeated here. It should be noted that the functions described in the various modules (sub-modules, units or components, etc.) in the first device 1000 of the embodiments of the present disclosure may be implemented by different modules (sub-modules, units or components, etc.) or by a same module (sub-module, unit or component, etc.).

FIG. 13 is a schematic block diagram of a second device 1300 according to an embodiment of the present disclosure. The second device 1300 may include:
a second communication module 1310 configured to transmit discovery request response information to a first device in response to receiving a discovery request from the first device on a first channel, where the discovery request response information includes network deployment information.

In an implementation, the network deployment information is used by the first device to determine a position of a beacon of a network device.

In an implementation, the first device includes a zero-power consumption device or an ambient power enabled Internet of Things device.

In an implementation, the first channel is pre-agreed or configured by the second device.

In an implementation, the first channel is randomly determined from N pre-agreed or pre-configured channels, where N is an integer greater than or equal to 2.

An operating frequency band of the first device 1000 includes M channels, where M is an integer greater than or equal to 1, and M is greater than N.

In an implementation, the network deployment information includes at least one of:
relevant information of one or more channels on which a network is deployed; or
relevant information of each network of at least one network.

In an implementation, the at least one network includes a network corresponding to the second device and/or a first network discovered by the second device.

In an implementation, as illustrated in FIG. 14, the second device further includes a third processing module 1410 configured to:
scan at least one frequency band to discover the first network.

In an implementation, the second communication module 1310 is further configured to:
transmit a probe request on at least one channel; where the probe request is used for indicating or requesting a third device on the at least one channel to transmit relevant information of the first network.

In an implementation, the relevant information of each network includes at least one of:
identification information related to the network;
a channel used by the network;
time-related information of a beacon of the network; or
first attribute information of the network.

In an implementation, the identification information of the network device includes at least one of a network identifier (ID), a cell ID, a service set identifier (SSID), or a basic service set identifier (BSSID).

In an implementation, the time-related information of the beacon of the network includes a period of the beacon, and/or, a time span between the beacon and the discovery request response information.

In an implementation, the first attribute information of the network includes at least one of:
whether the network supports access to the network by the zero-power consumption device capable of communicating via back scattering or the ambient power enabled IoT device capable of communicating via back scattering;
an operational level of the network; or
whether the network supports wireless power supply.

In an implementation, the discovery request response information further includes frequency deviation information, and the frequency deviation information is used by the first device to calibrate an operating frequency of the first device.

The second device 1300 in the embodiments of the present disclosure may implement the functions corresponding to the second device in the aforementioned method embodiments. The processes, functions, implementations and beneficial effects corresponding to various modules (sub-modules, units or components, etc.) in the second device 1300 may refer to the corresponding description in the above method embodiments, and details are not repeated here. It should be noted that the functions described in the various modules (sub-modules, units or components, etc.) in the second device 1300 of the embodiments of the present disclosure may be implemented by different modules (sub-modules, units or components, etc.) or by a same module (sub-module, unit or component, etc.).

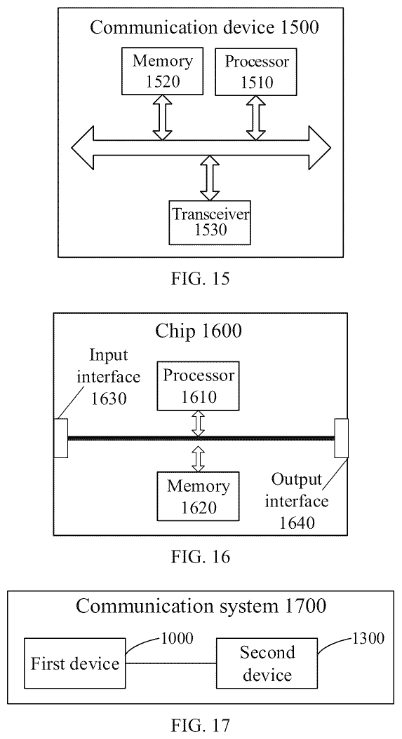

FIG. 15 is a schematic diagram illustrating a structure of a communication device 1500 according to an embodiment of the present disclosure. The communication device 1500 includes a processor 1510. The processor 1510 may call a computer program from a memory and run the computer program, so as to enable the communication device 1500 to perform the method in the embodiments of the present disclosure.

In an implementation, the communication device 1500 may further include a memory 1520. The processor 1510 may call the computer program from the memory 1520 and run the computer program, so as to enable the communication device 1500 to perform the method in the embodiments of the present disclosure.

The memory 1520 may be a separate device independent of the processor 1510, or may be integrated into the processor 1510.

In an implementation, the communication device 1500 may further include a transceiver 1530, and the processor 1510 may control the transceiver 1530 to communicate with other devices. For example, the transceiver 1530 may transmit information or data to other devices, or receive information or data transmitted by other devices.

The transceiver 1530 may include a transmitter and a receiver. The transceiver 1530 may further include antenna(s), and there may be one or more antennas.

In an implementation, the communication device 1500 may be the first device in the embodiments of the present disclosure, and the communication device 1500 may implement the corresponding processes implemented by the first device in various methods in the embodiments of the present disclosure, which will not be repeated here for brevity.

In an implementation, the communication device 1500 may be the second device in the embodiments of the present disclosure, and the communication device 1500 may implement the corresponding processes implemented by the second device in various methods in the embodiments of the present disclosure, which will not be repeated here for brevity.

FIG. 16 is a schematic diagram illustrating a structure of a chip 1600 according to an embodiment of the present disclosure. The chip 1600 includes a processor 1610. The processor 1610 may call a computer program from a memory and run the computer program, so as to implement the methods in the embodiments of the present disclosure.

In an implementation, the chip 1600 may further include a memory 1620. The processor 1610 may call the computer program from the memory 1620 and run the computer program, so as to implement the methods implemented by the first device in the embodiments of the present disclosure.

The memory 1620 may be a separate device independent of the processor 1610, or may be integrated into the processor 1610.

In an implementation, the chip 1600 may further include an input interface 1630. The processor 1610 may control the input interface 1630 to communicate with other devices or chips. For example, the processor 1610 may control the input interface 1630 to obtain information or data transmitted by other devices or chips.

In an implementation, the chip 1600 may further include an output interface 1640. The processor 1610 may control the output interface 1640 to communicate with other devices or chips. For example, the processor 1610 may control the output interface 1640 to output information or data to other devices or chips.

In an implementation, the chip may be applied to the first device in the embodiments of the present disclosure, and the chip may implement the corresponding processes implemented by the first device in various methods in the embodiments of the present disclosure, which will not be repeated here for brevity.

In an implementation, the chip may be applied to the second device in the embodiments of the present disclosure, and the chip may implement the corresponding processes implemented by the second device in various methods in the embodiments of the present disclosure, which will not be repeated here for brevity.

It should be understood that the chip mentioned in the embodiments of the present disclosure may also be referred to as a system-level chip, a system chip, a chip system or a system-on-chip chip, etc.

The processor mentioned above may be a general-purpose processor, a digital signal processor (DSP), a field programmable gate array (FPGA), an application specific integrated circuit (ASIC) or other programmable logic devices, a transistor logic device, a discrete hardware component, or the like. The general-purpose processor mentioned above may be a microprocessor or any conventional processor, or the like.

The above-mentioned memory may be a volatile memory or a non-volatile memory, or may include both the volatile memory and the non-volatile memory. The non-volatile memory may be a read-only memory (ROM), a programmable ROM (PROM), an erasable PROM (EPROM), an electrically ERPROM (EEPROM), or a flash memory. The volatile memory may be a random access memory (RAM).

It should be understood that the above memory is an exemplary but not restrictive description. For example, the memory in the embodiments of the present disclosure may be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), or a direct rambus RAM (DR RAM). That is, the memory in the embodiments of the present disclosure is intended to include, but not limited to, these and any other suitable types of memories.

FIG. 17 is a schematic block diagram of a communication system 1700 according to an embodiment of the present disclosure. The communication system 1700 includes the first device 1000 and the second device 1300.

The first device 1000 is configured to transmit the discovery request on the first channel; where the discovery request is used for indicating or requesting the second device 1300 on the first channel to transmit the discovery request response information, and the discovery request response information includes the network deployment information.

The second device 1300 is configured to transmit the discovery request response information to the first device 1000 in response to receiving the discovery request from the first device 1000 on the first channel. The discovery request response information includes the network deployment information.

The above embodiments may be implemented in whole or in part by software, hardware, firmware or any combination thereof. When implemented using software, the software may be implemented in a form of a computer program product in whole or in part. The computer program product includes one or more computer instructions. When the computer program instructions are loaded on and executed by a computer, processes or functions in the embodiments of the present disclosure are generated in whole or in part. The computer may be a general-purpose computer, a dedicated-purpose computer, a computer network, or any other programmable device. The computer instructions may be stored in a non-transitory computer-readable storage medium. Alternatively, the computer instructions may be transmitted from a computer-readable storage medium to another computer-readable storage medium. For example, the computer instructions may be transmitted from a website, a computer, a server, or a data center to another website, another computer, another server, or another data center via a wired manner (e.g., a coaxial cable, an optical fiber, a digital subscriber line (DSL)) or a wireless manner (e.g., infrared, radio, or microwave). The computer-readable storage medium may be any available medium accessible by the computer, or the computer-readable storage medium may be a data storage device, such as a server or a data center, integrated by one or more available mediums. The available medium may be a magnetic medium (e.g., a floppy disk, a hard disk, a magnetic tape), an optical medium (e.g., a digital video disc (DVD)), a semiconductor medium (e.g., a solid state disk (SSD)), or the like.

It should be understood that in various embodiments of the present disclosure, the sequence numbers of each of the above-described processes do not mean an execution order, and the execution order of each process should be determined by its function and internal logic, and should not constitute any limitation on the implementation of the embodiments of the present disclosure.

Those skilled in the art will clearly understand that, for the convenience and brevity of description, the working processes of the systems, devices and units described above may refer to the corresponding processes in the aforementioned method embodiments, and details are not repeated here.

The above description is only an exemplary implementation of the present disclosure, but the protection scope of the present disclosure is not limited thereto. Changes or replacements that any person skilled in the art could readily conceive of within the technical scope disclosed in the present disclosure shall be included in the protection scope of the present disclosure. Therefore, the protection scope of the present disclosure shall be subject to the protection scope of the claims.

What is claimed is:

1. A network discovery method, comprising:
transmitting, by a first device, a discovery request on a first channel; wherein the discovery request is used for indicating or requesting a second device on the first channel to transmit discovery request response information, and the discovery request response information comprises network deployment information.

2. The method according to claim 1, further comprising:
receiving, by the first device, the discovery request response information, and completing, by the first device, a network discovery based on the network deployment information.

3. The method according to claim 1, wherein the first device comprises a zero-power consumption device or an ambient power enabled Internet of Things device.

4. The method according to claim 1, wherein the first channel is pre-agreed or configured by the second device.

5. The method according to claim 1, wherein the first channel is randomly determined from N pre-agreed or pre-configured channels, N being an integer greater than or equal to 2;
wherein a frequency band where the first channel is located comprises M channels, M being an integer greater than N.

6. The method according to claim 1, wherein the network deployment information comprises at least one of:
relevant information of one or more channels on which a network is deployed; or
relevant information of each network of at least one network.

7. The method according to claim 6, wherein the at least one network comprises a network corresponding to the second device and/or a network discovered by the second device.

8. The method according to claim 6, wherein the relevant information of each network comprises at least one of:
identification information related to the network;
a channel used by the network;
time-related information of a beacon of the network; or
first attribute information of the network.

9. The method according to claim 8, wherein the identification information related to the network comprises at least one of a network identifier (ID), a cell ID, a service set identifier (SSID), or a basic service set identifier (BSSID).

10. The method according to claim 8, wherein the time-related information of the beacon of the network comprises a period of the beacon, and/or a time span between the beacon and the discovery request response information.

11. The method according to claim 8, wherein the first attribute information of the network comprises at least one of:
whether the network supports access to the network by a zero-power consumption device capable of communicating via back scattering or an ambient power enabled IoT device capable of communicating via back scattering;
an operational level of the network; or
whether the network supports wireless power supply.

12. The method according to claim 1, further comprising:
in response to determining relevant information of a plurality of networks based on one or more pieces of discovery request response information, selecting, by the first device, a second network from the plurality of networks for access; or
in response to determining relevant information of a plurality of networks based on one or more pieces of discovery request response information, accessing, by the first device, each of the plurality of networks separately.

13. A network discovery method, comprising:
in response to receiving a discovery request from a first device on a first channel, transmitting, by a second device, discovery request response information to the first device, wherein the discovery request response information comprises network deployment information.

14. The method according to claim 13, wherein the network deployment information is used by the first device to complete a network discovery.

15. The method according to claim 13, wherein the network deployment information comprises at least one of:
relevant information of one or more channels on which a network is deployed; or
relevant information of each network of at least one network.

16. The method according to claim 15, wherein the at least one network comprises a network corresponding to the second device and/or a first network discovered by the second device.

17. The method according to claim 16, further comprising:
scanning, by the second device, at least one frequency band to discover the first network; or
transmitting, by the second device, a probe request on at least one channel; wherein the probe request is used for indicating or requesting a third device on the at least one channel to transmit relevant information of the first network.

18. The method according to claim 13, wherein the discovery request response information further comprises frequency deviation information, and the frequency deviation information is used by the first device to calibrate an operating frequency of the first device.

19. A first device, comprising:
a first communication module, configured to transmit a discovery request on a first channel; wherein the discovery request is used for indicating or requesting a second device on the first channel to transmit discovery request response information, and the discovery request response information comprises network deployment information.

20. A second device, comprising:
a second communication module, configured to transmit discovery request response information to a first device in response to receiving a discovery request from the first device on a first channel, wherein the discovery request response information comprises network deployment information.
